(19) United States
(12) Patent Application Publication
(10) Pub. No.: US 2023/0406128 A1
(43) Pub. Date: Dec. 21, 2023

(54) CHARGING STATION

(71) Applicant: AUDI AG, Ingolstadt (DE)

(72) Inventor: Sebastian VAHLE, Landshut (DE)

(21) Appl. No.: 18/317,775

(22) Filed: May 15, 2023

(30) Foreign Application Priority Data
May 17, 2022 (DE) 10 2022 112 271.9

(51) Int. Cl. B60L 53/31; B60L 53/18; E01F 13/02

(52) U.S. Cl. CPC B60L 53/31; B60L 2270/32; E01F 13/02; B60L 53/18

(57) ABSTRACT

A system for a charging station having an integrated and extendable warning bollard and a charging cable protector, and a method for its operation.

### BACKGROUND

### Technical Field

Embodiments of the present disclosure relate to a charging station having an integrated and extendable warning bollard and a charging cable protector and a method for its operation.

### Description of the Related Art

Charging stations are known, serving for the charging of plug-in hybrid electric vehicles (PHEV) and battery electric vehicles (BEV). The charging cable is either a component of the charging station or the charging station has only one charging receptacle and the vehicle's own charging cable is used as the charging cable. In the case of charging stations with integrated charging cable, the charging cable is generally situated at the height of the user and is freely accessible. When the charging cable is attached to the vehicle (either a charging cable permanently installed at the charging station or the vehicle's own charging cable), the charging cable lies loose on the ground or hangs down at the bridging height between the charging station and the car. There is a danger of passers by getting caught on the cable or tripping over the cable, especially since the charging process for electric vehicles takes a long time and the owner of the vehicle is not present at the vehicle and watching the charging process, so they cannot warn passers by. Furthermore, in the case of a charging station with integrated charging cable, there is the danger of a damaging the charging cable by vandalism or theft, and a fouling of the charging cable due to dirt and grime.

From the document JP 2012-120 402 A there is known a charger for charging a battery mounted on an electric vehicle, having a charging cable which connects the charger and the battery; an arm, extending and retracting in a substantially horizontal direction; and a supporting body having a first support piece, which holds the charging cable at a first position in a lengthwise direction, in which the arm expands and retracts, and a second support piece, which holds the charging cable at a second position in the lengthwise direction, in which the arm extends and retracts. The distance between the first support piece and the second support piece is increased when the arm is extended, and decreases when the arm is retracted, so that the charging cable buckles and hangs down when the arm is retracted.

The document CN 113 232 541 A relates to a charging station for an electric vehicle having a telescopic piece, a camera and a sensor. The telescopic component moves a charging plug up to the vehicle into a position close to the vehicle, so that the charging station can be used conveniently. After the charging process is finished, the telescopic component retracts the charging plug and moves toward the interior of the charging station. The charging cable is suspended in the air by the telescopic component, so that damage due to friction between the cable and the ground is avoided and the service life of the cable is longer.

The document CN106 945 553 A discloses a charging station for electric vehicles, comprising a charging station body, a charging plug, and a connection cable for connecting the charging station to the charging gun. A first connection rod is arranged at the lower end of the charging station. One end of the first connection rod is firmly attached to the charging station body, the other end of the first connection rod is connected rotatably by a first rotary shaft to a first support rod. The top end of the first support rod is provided with a second connection rod perpendicular to the first support rod, the other end of the second connection rod is connected rotatably by a second rotary shaft to a second support rod, the first rotary shaft and the second rotary shaft being each provided with a torsion spring, and the first support rod and the second support rod are parallel to each other in the nonstretched state of the torsion springs.

### BRIEF SUMMARY

Some embodiments provide a device and a method which effectively reduce the danger of tripping over charging cables lying around and protect the charging cable against vandalism and fouling with dirt and grime when it is not being used.

Some embodiments include a charging station having an integrated warning bollard, which can move between a first position in which the warning bollard is at least mostly situated inside the charging station and a second position in which the warning bollard is situated entirely outside the charging station, wherein the warning bollard in the first position can be locked by a locking mechanism in the charging station.

The charging station comprises an integrated warning bollard, which can move between a first position and a second position. In one embodiment, the side of the charging station in which the warning bollard is integrated is a flat surface. In one embodiment, the charging station has a rectangular or square cross section. In one embodiment, the warning bollard has a rectangular or square cross section. In the first position, the warning bollard is at least mostly situated inside the charging station, i.e., the warning bollard can possibly protrude beyond the outer surface of the charging station. In one embodiment, the warning bollard in the first position is situated entirely inside the charging station. In another embodiment, the warning bollard is flush with the outer surface of the charging station.

In one embodiment, the warning bollard is moved by a rail system between the first and the second position. In another embodiment, the warning bollard can be locked on the rail system by a securing mechanism. With the securing mechanism, the warning bollard can be secured in a desired position depending on the distance of the motor vehicle from the charging station. In one embodiment, the warning bollard has a recessed grip on one side facing away from the charging station, by which the user of the charging station can pull out and extend the warning bollard. In another embodiment, the rail system can be driven out from the charging station and driven back into the charging station.

In one embodiment, the warning bollard may include a securing device or structure for securing a charging cable on its top side. In one embodiment, the securing device or structure for securing a charging cable may comprise a cable guide. In another embodiment, the securing device or structure for securing a charging cable may comprise one or more clips, in which the charging cable can be locked.

In one embodiment, the warning bollard has at least one warning marking on its sides situated parallel to the connection axis between the charging station and the warning bollard. In another embodiment, the warning bollard is provided with warning paint and a warning sign (for example: “Attention: charging cable!”). In another embodiment, the warning markings have a lighting, which is controlled by a brightness sensor. For example, the warning bollard can be provided with at least one lighting unit and one brightness sensor, which activates the lighting when it is dark out.

In one embodiment, the charging station comprises an integrated charging cable, which is received entirely in a cavity of the charging station when the warning bollard is in the first position. The charging cable is then located behind the warning bollard in the interior of the charging station and is thus protected against damage and fouling.

The warning bollard in the first position can be locked by a locking mechanism in the charging station. In one embodiment, the warning bollard is locked in the charging station when the warning bollard moves into the first position, i.e., when it is retracted into the charging station. In one embodiment, the charging station is adapted to unlock the locking mechanism when a user reports to the charging station.

Some embodiments include a method for operating the charging station described herein. The locking mechanism unlocks the warning bollard which has been locked in the charging station when a user reports to the charging station, and the warning bollard is transferred from the first position to the second position. The integrated charging cable is connected to a charging socket of an electric vehicle to be charged and secured on the warning bollard.

Thanks to the process of a user reporting to the charging station, the locking is released and the warning bollard can be driven out by the user at the handle and locked in the desired position (depending on the distance from the motor vehicle). The charging cable is thus accessible and can be taken by the user to the charging receptacle of the motor vehicle via the warning bollard and secured on the warning bollard.

In one embodiment of the method, after the end of a charging process the charging cable is placed in a cavity of the charging station and the warning bollard is moved from the second position to the first position and locked by the locking mechanism in the charging station. After the charging process, the charging cable is once again secured in the charging station and the warning bollard is again secured by the locking mechanism. Only then is the charging process completed for the customer.

Thanks to the charging station with extendable warning bollard and charging cable guide, the danger of tripping over a charging cable lying around is effectively reduced. Furthermore, the charging cable does not get as dirty, since it is not lying on the ground, and the charging cable is protected against vandalism and fouling when not in use. Further benefits and configurations of the disclosure will emerge from the specification and the drawings.

Of course, the previously mentioned features can be used not only in the particular indicated combination, but also in other combinations or standing alone, without leaving the scope of the present disclosure.

### BRIEF DESCRIPTION OF THE SEVERAL VIEWS OF THE DRAWINGS

The present disclosure is presented schematically with the aid of one embodiment in the drawings and shall be further described with reference to the drawings.

FIG. 1 shows a schematic representation of one embodiment of the charging station in the closed state.

FIG. 2 shows a schematic representation of one embodiment of the charging station in the opened state.

### DETAILED DESCRIPTION

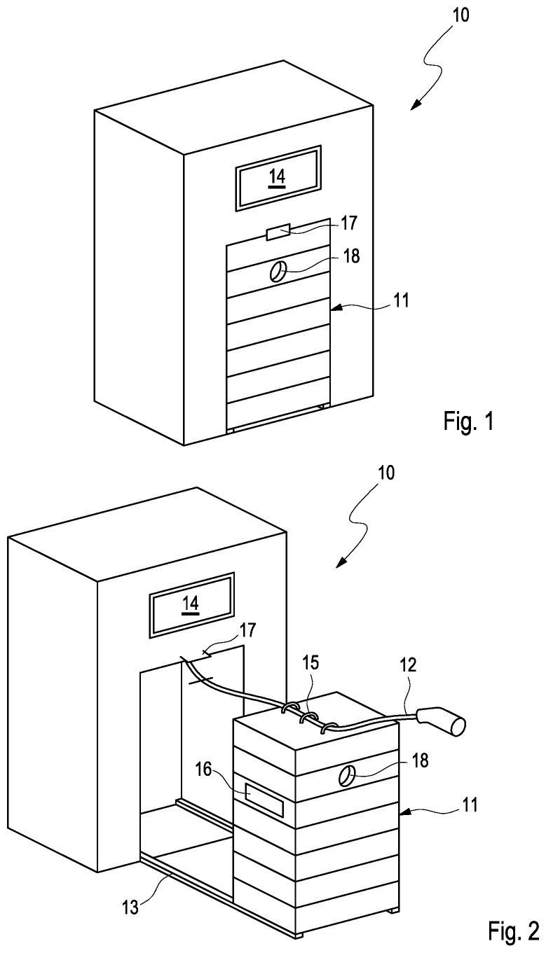

FIG. 1 shows schematically one embodiment of the charging station 10 in the closed state. The extendable warning bollard 11 is retracted and secured by the locking mechanism 17. The charging station 10 recognizes the locked status of the warning bollard 11. The warning bollard 11 has a recessed grip 18, by which the warning bollard 11 can be pulled out from the charging station 10. The locked status of the charging station 10 can be indicated on the display 14.

FIG. 2 shows schematically the charging station 10 in the opened state. The extendable warning bollard 11 is extended by a rail system 13 with securing mechanism designed for a heavy load and secured in the desired end position. The charging cable 12 integrated in the charging station 10 is pulled out and secured in a charging cable guide 15 on the top side of the warning bollard 11, for example, by one or more clips. The warning bollard 11 has optical warning notices 16 on its sides, optionally outfitted with lighting and a brightness sensor. The warning notices 16 are meant to keep passers by from going between the charging station 10 and a connected electric vehicle and thereby tripping over the charging cable 12.

German patent application no. 10 2022 112271.9, filed May 17, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging station, comprising:
an integrated warning bollard, which can move between a first position in which the warning bollard is at least mostly situated inside the charging station, and a second position in which the warning bollard is situated entirely outside the charging station, wherein the warning bollard in the first position can be locked by a locking mechanism in the charging station.

2. The charging station according to claim 1, wherein the warning bollard is moved by a rail system between the first and the second position.

3. The charging station according to claim 2, wherein the warning bollard can be locked on the rail system by a securing mechanism.

4. The charging station according to claim 1, wherein the warning bollard has a recessed grip on one side facing away from the charging station.

5. The charging station according to claim 1, being adapted to unlocking the locking mechanism when a user reports to the charging station.

6. The charging station according to claim 1, wherein the warning bollard (11) has a securing device or structure that can secure a charging cable on a top side of the warning bollard.

7. The charging station according to claim 1, wherein the warning bollard has warning markings on sides thereof which are situated parallel to a connection axis between the charging station and the warning bollard.

8. The charging station according to claim 1, comprising an integrated charging cable, which is received entirely in a cavity of the charging station when the warning bollard is in the first position.

9. A method for operating a charging station having an integrated warning bollard which can move between a first position in which the warning bollard is at least mostly situated inside the charging station, and a second position in which the warning bollard is situated entirely outside the charging station, wherein the warning bollard in the first position can be locked by a locking mechanism in the charging station, the method comprising:
unlocking the warning bollard using the locking mechanism which has been previously locked in the charging station when a user reports to the charging station; and
transferring the warning bollard from the first position to the second position with an integrated charging cable secured on the warning bollard to enable the integrated charging cable to be connected to a charging socket of an electric vehicle to be charged.

10. The method according to claim 9, further comprising:
after an end of a charging process, placing the charging cable in a cavity of the charging station and moving the warning bollard from the second position to the first position and locking the warning bollard in the first position by the locking mechanism in the charging station.
